(19) United States
(12) Patent Application Publication
(10) Pub. No.: US 2009/0237731 A1
(43) Pub. Date: Sep. 24, 2009

(54) Printing System, Printer and Driver Program

(75) Inventor: Koji TANAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/408,239

(22) Filed: Mar. 20, 2009

(30) Foreign Application Priority Data
Mar. 24, 2008 (JP) 2008-076479

(51) Int. Cl. G06F 3/12

(52) U.S. Cl. 358/1.15

(57) ABSTRACT

A printing system includes: a printer which generates bitmap data from received print data to perform printing for each predetermined range, generates an intermediate code from the print data to generate the bitmap data from the intermediate code when the print data is expressed by a printer control language, and generates the bitmap data from the intermediate code when the print data is expressed by the intermediate code; and a host device which transmits the print data to the printer to issue a print request. When the printer receives the print data expressed by the printer control language and memory shortage occurs during the generation of the intermediate code, the printer notifies the host device of the memory shortage. The host device receiving the notification generates the intermediate code of the predetermined range in which the memory shortage occurs, and transmits the generated intermediate code as the print data to the printer.

### BACKGROUND

1. Technical Field

The present invention relates to a printing system which includes a host device issuing a print request and a printer performing printing in response to the request, and more particularly, to a printing system which has improved convenience when memory shortage occurs in a printer.

2. Related Art

In a printing system which includes a host device issuing a print request and a printer performing printing in response to the request, print data corresponding to the print request from the host device is transmitted to the printer to perform printing based on the print data. In this case, there are several levels of print data to be transmitted, and for example, print data expressed by a page-description language (PDL) that is a printer control language is transmitted to the printer. In this case, the printer receiving the PDL converts the information into a format of a drawing code as an intermediate code that is easily subjected to a subsequent process, and then generates bitmap data that is image data for each pixel from the intermediate code. In addition, there are some cases where the host device may generate the intermediate code and transmit the intermediate code as the print data to the printer. There are also some cases where the host device may generate the bitmap data and transmit the bitmap data as the print data to the printer.

In JP-A-10-40031, it has been proposed that a format of data to be output to a printer is automatically selected. In the system described in JP-A-10-40031, which format of data is output is evaluated from device specifications of a host device and a printer. Data format to be output is selected based on the result of the evaluation.

Recently, in the above printing system, a data amount of an image to be printed has been increased and thus there is an increased possibility that memory shortage may occur when the printer creates an intermediate code.

In the above-described known device, when memory shortage occurs in the printer during the creation of the intermediate code, an error occurs and processing on the page on which the error occurs is stopped. When such a problem occurs, it is required that a user performs a data amount reduction process, such as lowering the resolution of the page, and then performs printing on the page once again. Accordingly, the device has a problem in convenience. In this case, since the data amount reduction process is performed, it results in deterioration of an output quality.

### SUMMARY

An advantage of some aspects of the invention is that it provides a printing system which includes a host device issuing a print request and a printer performing printing in response to the request and has improved convenience when memory shortage occurs in the printer.

According to an aspect of the invention, a printing system includes: a printer which generates bitmap data from received print data to perform printing for each predetermined range, generates an intermediate code from the print data to generate the bitmap data from the intermediate code when the print data is expressed by a printer control language, and generates the bitmap data from the intermediate code when the print data is expressed by the intermediate code; and a host device which transmits the print data to the printer to issue a print request. When the printer receives the print data expressed by the printer control language and memory shortage occurs during the generation of the intermediate code, the printer notifies the host device of the memory shortage. The host device receiving the notification generates the intermediate code of the predetermined range in which the memory shortage occurs, and transmits the generated intermediate code as the print data to the printer.

According to this aspect of the invention, it is preferable that the memory shortage occurs in the printer when an intermediate code generation process including the reduction of the capacity of the generated intermediate code of the predetermined range as a target to be processed is continuously performed after the memory shortage during the generation of the intermediate code, but the memory is short in spite of the process including the reduction of the capacity.

According to this aspect of the invention, it is preferable that the host device reduces the capacity of the intermediate code generated by receiving the notification to transmit the intermediate code to the printer.

According to this aspect of the invention, it is preferable that, when the printer receives the intermediate code generated and transmitted from the host device and memory shortage occurs to disenable the storage of the intermediate code, the printer notifies the host device of the memory shortage, and it is preferable that the host device receiving the notification generates the intermediate code after simplification of an image to be printed for the predetermined range in which the memory shortage occurs, and transmits the generated intermediate code as the print data to the printer.

According to this aspect of the invention, it is preferable that the simplification is performed in different manners in accordance with the kind of image objects of the image to be printed.

According to another aspect of the invention, a printer generates bitmap data from print data received from a host device to perform printing for each predetermined range, generates an intermediate code from the print data to generate the bitmap data from the intermediate code when the print data is expressed by a printer control language, and generates the bitmap data from the intermediate code when the print data is expressed by the intermediate code. When the printer receives the print data expressed by the printer control language and memory shortage occurs during the generation of the intermediate code, the printer notifies the host device of the memory shortage. The printer receives the intermediate code, which is generated by the host device, of the predetermined range in which the memory shortage occurs, and performs printing based on the received intermediate code.

According to further another aspect of the invention, a record medium recorded a driver program causes a host device to generate and transmit print data, the host device issuing a print request to a printer which generates bitmap data from the received print data to perform printing for each predetermined range, generates an intermediate code from the print data to generate the bitmap data from the intermediate code when the print data is expressed by a printer control language, and generates the bitmap data from the intermediate code when the print data is expressed by the intermediate code. When the printer receives the print data expressed by the printer control language and memory shortage occurs during the generation of the intermediate code by the printer, the driver program causes the host device to receive a notification of the memory shortage from the printer, generate the intermediate code of the predetermined range in which the memory shortage occurs, and transmit the generated intermediate code as the print data to the printer.

The objects and features of the invention become clear from embodiments of the invention to be described later.

### BRIEF DESCRIPTION OF THE DRAWINGS

The invention will be described with reference to the accompanying drawings, wherein like numbers reference like elements.

FIG. 1 is a configuration diagram illustrating a printing system according to an embodiment of the invention.

FIG. 2 is a diagram illustrating data of an image to be printed.

FIG. 3 is a flowchart illustrating a procedure of a process for a page on which a process is started in a printer page mode.

### DESCRIPTION OF EXEMPLARY EMBODIMENTS

Hereinafter, embodiments of the invention will be described with reference to the drawings. However, the technical scope of the invention is not limited to the embodiments. In the drawings, the same reference numbers are given to the same constituent elements.

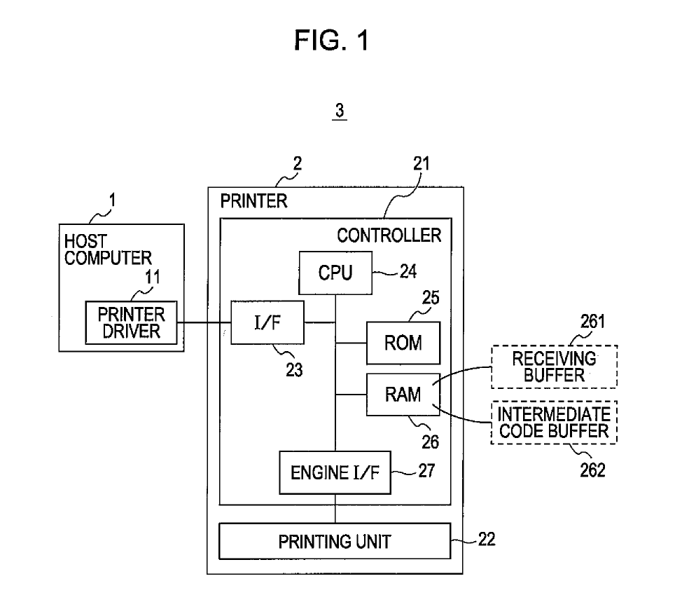

FIG. 1 is a configuration diagram illustrating a printing system according to an embodiment of the invention. A printing system 3 illustrated in FIG. 1 is the printing system according to the embodiment of the invention, and includes a host computer 1 as a host device for issuing a print request and a printer 2 for performing printing. The printing system can be operated in a mode (referred to as the printer page mode) in which the host computer 1 transmits print data in a PDL upon issuing a print request and a mode (referred to as the driver page mode) in which the host computer 1 transmits the print data in an intermediate code format. When memory shortage occurs during the generation of the intermediate code in the printer 2 operated in the printer page mode, the mode is switched to the driver page mode to generate an intermediate code of the page on which the memory shortage occurs in the host computer 1 and transmit the intermediate code once again. The printing system is provided to improve convenience when such a situation occurs.

As described above, the host computer 1 illustrated in FIG. 1 is a host device for issuing a print request to the printer 2 and generates print data based on user's operations to transmit the print data to the printer 2. The host computer 1 may include a so-called personal computer.

A printer driver 11 in the host computer 1 is a driver for the printer 2 and receives data from an application (not shown) in the host computer 1 to generate the print data to be transmitted to the printer 2. As described above, the printing system has the printer page mode and the driver page mode, and the printer driver 11 generates the print data in a PDL format in the printer page mode and generates the print data in an intermediate code format in the driver page mode. The mode for each print job may be selected by the user or automatically selected by the driver from device specifications.

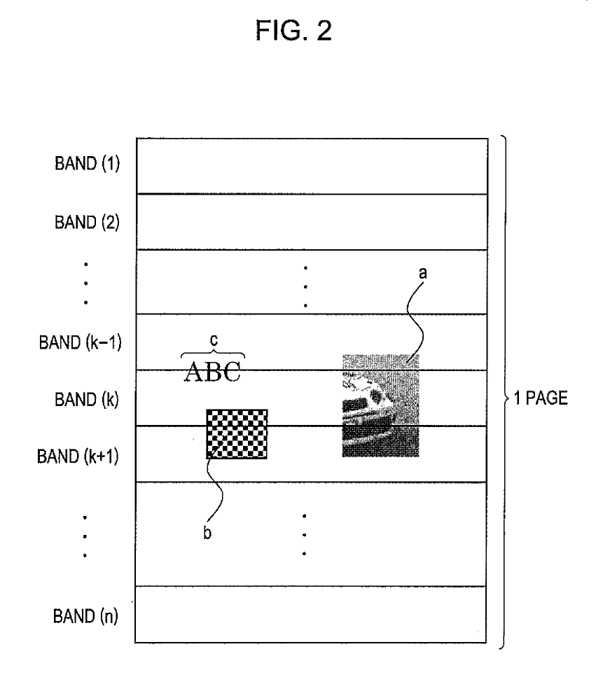

FIG. 2 is a diagram illustrating data of an image to be printed. In FIG. 2, an image to be printed for one page is shown and the image includes an image object a of an image, an image object b of graphics and an image object c of a text. Information of the image objects is transferred in a predetermined data format to the printer driver 11 from an application of the print request source. Then, in the printer page mode, the printer driver 11 generates print data by the PDL on the basis of the data. In the print data, the information is expressed in a drawing code format for each of the image objects.

In processing after the processing for the intermediate code, the information (data) for one page is processed for each divided area referred to as the band. Accordingly, an intermediate code generated based on the data by the printer driver 11 in the driver page mode and an intermediate code generated based on the PDL by the printer 2 in the printer page mode become drawing codes for each image object divided for each band. Herein, the band is a divided area obtained by dividing one page in a vertical scanning direction (sheet transport direction), as illustrated in FIG. 2. As illustrated in FIG. 2, one page is divided into n bands (from band (1) to band (n)).

Since the image object a illustrated in FIG. 2 extends over three bands (band (k−1), band (k) and band (k+1)), the image object a is divided into the three bands and an intermediate code is generated for each band. The image objects b and c are also divided into two bands, respectively, and an intermediate code is generated for each band. In each band, an intermediate code is generated for a part included in the bands of each image object.

Accordingly, for example, in the band (k), drawing codes are generated in an intermediate part included in the bands of the image object a, an upper part of the image object b and a lower part of the image object c.

Like the image object a, when the kind of an image object is an image, image data to be drawn in the band is stored at a predetermined position in an intermediate code buffer 262 to be described later, and the intermediate code has an address for the stored image (referred to as the source image) as pointer information. In addition, like the image object b, when the kind of an image object is graphics and is expressed in the same painting pattern, the pattern data is stored at a predetermined position in the intermediate code buffer 262, and the intermediate code has an address for the stored pattern data (referred to as the source pattern) as pointer information.

The printer driver 11 includes a program for instructing a process for the above-described functions and a control device (not shown) for the host computer 1 performing the process in accordance with the program.

Next, the printer 2 is, for example, a 4-cycle color laser printer which includes a controller 21 and a printing unit 22 as illustrated in FIG. 1.

The controller 21 receives the print data transmitted from the host computer 1 to interpret control contents included in the data and perform a predetermined process for image data included in the data to thereby generate data to be provided to the printing unit 22. As illustrated in FIG. 1, the controller 21 includes an I/F 23, a CPU 24, a ROM 25, a RAM 26 and an engine I/F 27.

The I/F 23 receives the print data transmitted from the host computer 1. The ROM 25 stores various programs for controlling the printer 2.

The RAM 26 is a memory for temporarily holding data and the like during the process of the controller 21, and areas for a receiving buffer 261 for storing the print data transmitted from the host computer 1 and the intermediate code buffer 262 for storing the intermediate codes are ensured in the RAM 26. The intermediate code buffer 262 is an area which stores the generated intermediate codes and temporarily holds the data required for generating the intermediate codes. When the area for the intermediate code buffer 262 cannot be not sufficiently ensured, memory shortage occurs and the intermediate codes cannot be generated.

The CPU 24 controlling various processes performed in the printer 2 particularly conducts a process of storing the received print data in the RAM 26, a process of interpreting the control contents of the print data to instruct the printing unit 22 to properly perform printing and a process of controlling an operation unit which forms an interface with the user. The printer 2 has characteristics in an intermediate code generation process of the CPU 24 and the specific contents thereof will be described later. The process performed by the CPU 24 is performed in accordance with a program stored in the ROM 25.

During the printing in the printing unit 22, the engine I/P 27 reads the intermediate codes stored in the intermediate code buffer 262 of the RAM 26 at a predetermined timing and subjects the intermediate codes to a predetermined process to transfer the intermediate codes to the printing unit 22. In this manner, the engine I/F 27 serves as an interface for the controller 21 and the printing unit 22. Specifically, a process of developing the read intermediate codes to be converted into bitmap data, a screen process, a pulse-width modulation process and the like are performed by being synchronized with the operation of the printing unit 22 and a signal after the process is transmitted to the printing unit 22.

Next, the printing unit 22 includes a charging unit, an exposure unit, a development unit, a transfer unit and a fixing unit (not shown). In the printing unit 22, printing is performed in accordance with a printing instruction from the CPU 24 on the basis of a signal received from the engine I/F 27 and an image is formed on a predetermined printing medium in accordance with the print request.

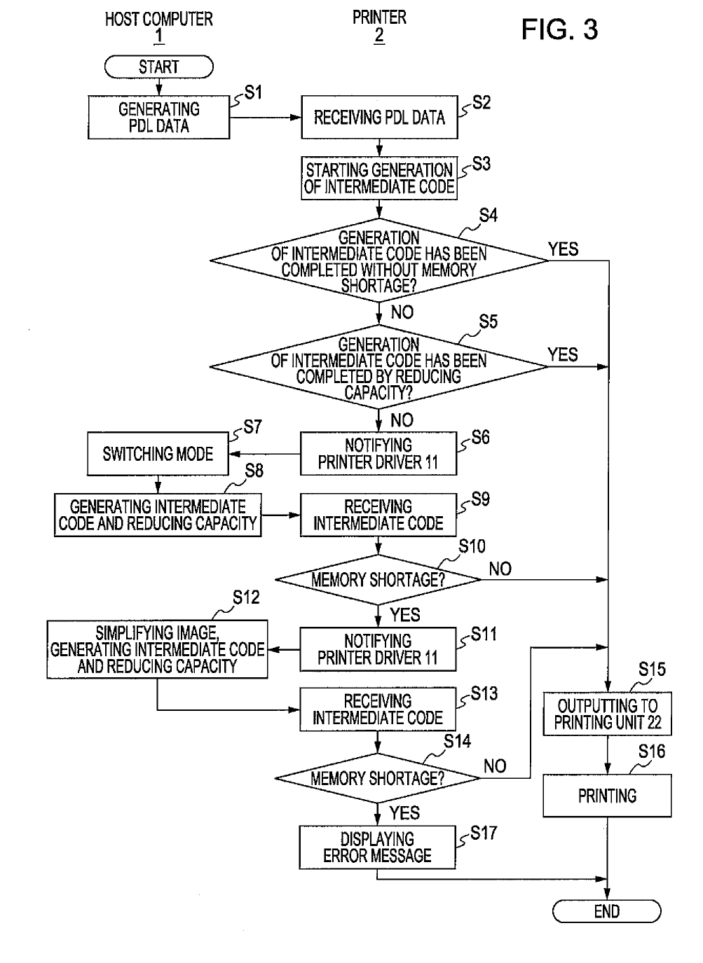

The printing system 3 having the above-described configuration according to this embodiment has characteristics in a process during the operation in the printer page mode and the process will be described later. FIG. 3 is a flowchart illustrating a procedure of a process for a page on which the process is started in the printer page mode. Hereinafter, the process for a print job for one page will be described based on FIG. 3.

First, when the host computer 1 issues a print request, the printer driver 11 generates print data for the printer 2, as described above. Herein, the operation is performed in the printer page mode, and thus the print data is generated in a PDL format (Step S1) and the printer 2 receives the data (Step S2). The received PDL data is stored in the above-described receiving buffer 261.

Then, by the CPU 24, a process of generating the above-described intermediate codes from the PDL data is started (Step S3). In the intermediate code generation process, the PDL data is read and interpreted one by one. When the data is related to an image object, intermediate codes for drawing the image object are generated. As described above, the intermediate codes are generated by dividing an image for each band. Accordingly, when the image object expressed by the PDL data is present over the plural bands, the intermediate codes of the image object of the plural bands are generated and then registered at storage positions for each band in the intermediate code buffer 262. Moreover, as described above, a source image and a source pattern are also stored in accordance with the kind of the image object.

In such an intermediate code creation process, a working area for performing the process by developing the PDL data for generating the intermediate codes and an area in which the generated intermediate codes are registered are required to be ensured as the intermediate code buffer 262 in the RAM 26. In addition, there are some cases where the working area for the PDL data expressing an image object of an image may require a much larger area than the generated intermediate codes. For example, there is a case where an image resolution of the image attached as the PDL data is higher than a resolution used in printing and a case where only a part of the attached image is used in printing.

Accordingly, a memory capacity required for the intermediate code buffer 262 in the intermediate code generation process may not be ensured. When all the intermediate codes of the page are generated without the occurrence of memory shortage (Yes in Step S4), the process proceeds normally to a next step (Step S15).

In the intermediate code generation process, when the memory shortage occurs (No in Step S4), the CPU 24 continues the intermediate code generation process by reducing the capacity of the previously generated intermediate codes. In reducing the capacity, when the previously generated intermediate codes include the above-described source image and source pattern, a process of compressing the data or a process of performing the development for the generated intermediate codes in the above-described engine I/F 27 is performed and then compressing the bitmap data after the development is performed. At this time, the capacity is reduced to the minimum.

After the reduction of the capacity, the conversion of the PDL data into the intermediate codes proceeds. When memory shortage occurs again, the same capacity reduction process is performed to continuously perform the process, and when all the intermediate codes of the page are generated (Yes in Step S5), the process proceeds to a next step (Step S15).

When all the intermediate codes of the page cannot be generated with the memory shortage in any stage in the intermediate code generation process including the reduction of the capacity (No in Step S5), the CPU 24 notifies the printer driver 11 of the above fact (Step S6). That is, it is notified that the memory shortage occurs and thus printing cannot be performed on the page.

The notification may be performed at the time when the memory shortage occurs without the reduction of the capacity (at the time of No in Step S4).

The printer driver 11 receiving the notification switches the mode to the driver page mode (Step S7).

After that, in the driver page mode, the printer driver 11 generates intermediate codes of the page and retransmits the intermediate codes as print data to the printer 2 (step S8). At this time, the capacity of the generated intermediate codes is reduced as above and the intermediate codes are transmitted to the printer 2 in a state in which the capacity becomes minimum. Specifically, for each band, the generated intermediate code is subjected to the compression of the source image and the source pattern (conversion into bitmap data) or the development and compression process to provide a format in which the capacity becomes minimum for each band. In the band subjected to the development and compression process, an intermediate code is generated by a bitmap image after the compression and a pointer indicating the bitmap data. This is the same as in the case where the reduction of the capacity is performed in Step S5.

The transmitted intermediate codes of the page are received by the printer 2 (Step S9) and the storage of the intermediate codes in the intermediate code buffer 262 is tried. At this time, the intermediate codes generated in Step S5 are discarded. When the intermediate codes are stored without the occurrence of memory shortage (No in Step S10), the process proceeds to Step S15.

When the memory shortage occurs and the intermediate codes cannot be stored (Yes in Step S10), the CPU 24 notifies the printer driver 11 of the above fact (Step S11). Since all the print data received this time are previously generated intermediate codes and the working area required for generating the intermediate codes is not required, a risk of the memory shortage is lower than in the case where the intermediate codes are generated in the printer 2. However, there are some cases where the intermediate codes have a large size in accordance with the image to be printed.

The printer driver 11 receiving the notification simplifies the image to be printed on the page and then the intermediate codes of the simplified image are created and the capacity of the intermediate codes is reduced as in Step S8. The intermediate codes after the process are transmitted as the print data to the printer 2 (Step S12).

For the simplification of the image, various methods can be used. For example, a method of changing a color image into a gray-scale image (removing color), a method of lowering the resolution of a color (reducing density gradation number of each color), a method of lowering the resolution of an image and the combination thereof can be used. In addition, a different simplification method may be used for each kind of image object. For example, an image resolution can be lowered for an image, only a line can be simplified for graphics, and a text is not simplified. In this manner, image quality deterioration caused by the simplification can be suppressed small.

The transmitted intermediate codes are received by the printer 2 again (Step S13) and the storage of the intermediate codes in the intermediate code buffer 262 is tried. At this time, the intermediate codes received in Step S9 are discarded. When the intermediate codes are stored without the occurrence of memory shortage (No in Step S14), the process proceeds to Step S15.

When the memory shortage occurs and the intermediate codes cannot be stored (Yes in Step S14), the CPU 24 displays an error message on a display unit (not shown) of the printer 2 and a display device (not shown) of the host computer 1 (Step S17) to complete the process for the page. That is, printing on the page is abandoned.

When the process proceeds to Step S15, the intermediate codes of the page are aligned in the intermediate code buffer 262 and thus the process of the above-described engine I/F 27 is started at a predetermined timing to output a signal after the process to the printing unit 22. After that, printing of the printing unit 22 is performed based on the signal and a sheet after the printing is discharged from the printer 2 (Step S16).

In this manner, the process for the page is completed.

In the above description, when the intermediate codes is generated in Step S8 and memory shortage occurs, the image is simplified and the capacity of the intermediate codes is made small. However, at the time when the intermediate codes are generated in Step S8 and the memory shortage occurs, printing on the page may be abandoned without the simplification. The simplification of the image causes deterioration of an output quality. Accordingly, the quality can be ensured by abandoning the printing. The user may set whether the process is performed up to the simplification of the image.

As described above, there are plural methods for the simplification of the image. Accordingly, for example, plural levels of the simplification may be provided in order of a smaller degree of image deterioration to sequentially and repeatedly perform the simplification, the generation of the intermediate codes and the transmission of the intermediate codes for each level to thereby resolve the memory shortage in the printer 2.

As described above, in the printing system 3 according to this embodiment, on a page on which the process is started in the printer page mode, when memory shortage occurs during the generation of the intermediate codes in the printer 2, the above mode is automatically switched to the driver page mode to generate the intermediate codes of the page in the host computer 1 and transmit the intermediate codes to the printer 2. Generally, since the host computer 1 has a memory having a larger capacity than that of the printer 2, the host computer 1 can generate the intermediate codes of the page on which memory shortage occurs in the printer 2. Accordingly, the printer 2 does not require the working area for generating the intermediate codes of the page and thus a risk of the memory shortage on the page is reduced and it is highly possible that printing can be performed well. Thus, a chance of completing the printing without the stop of the printing of the page when the memory shortage occurs is increased and convenience of the user can be improved.

When memory shortage occurs during the generation of the intermediate codes in the printer 2, the above-described reduction of the capacity is tried. In this manner, the memory shortage may be resolved and thus a chance of completing the printing without the stop of the printing of the page is increased and convenience of the user can be improved.

Moreover, it is highly possible that the above-described reduction of the capacity after the generation of the intermediate codes is performed even during the switch to the driver page mode and the printing on the page can be performed well. Accordingly, convenience of the user can be improved.

In addition, when the memory shortage occurs in the printer 2 despite the switch to the drive page mode, the above-described simplification of the image is performed. Accordingly, the image is deteriorated, but the printing on the page can be completed without the stop of the printing.

Moreover, as described above, the simplification of the image is performed in different manners in accordance with the kind of image objects and image deterioration caused by the simplification can be suppressed small.

In the above embodiments, the development and the subsequent processes after the generation of the intermediate codes are synchronized with the operation of the printing unit 22. However, the process up to the development may be previously performed to hold the bitmap data and the subsequent processes may be synchronized with the operation of the printing unit 22.

The protective scope of the invention is not limited to the embodiments and includes the invention described in the claims and equivalents thereof.

The entire disclosure of Japanese Patent Application No. 2008-076479, filed Mar. 24, 2008 is expressly incorporated by reference herein.

What is claimed is:

1. A printing system comprising:
a printer which generates bitmap data from received print data to perform printing for each predetermined range, generates an intermediate code from the print data to generate the bitmap data from the intermediate code when the print data is expressed by a printer control language, and generates the bitmap data from the intermediate code when the print data is expressed by the intermediate code; and
a host device which transmits the print data to the printer to issue a print request,
wherein when the printer receives the print data expressed by the printer control language and memory shortage occurs during the generation of the intermediate code, the printer notifies the host device of the memory shortage, and
wherein the host device receiving the notification generates the intermediate code of the predetermined range in which the memory shortage occurs, and transmits the generated intermediate code as the print data to the printer.

2. The printing system according to claim 1,
wherein the memory shortage occurs in the printer when an intermediate code generation process including the reduction of the capacity of the generated intermediate code of the predetermined range as a target to be processed is continuously performed after the memory shortage during the generation of the intermediate code, but the memory is short in spite of the process including the reduction of the capacity.

3. The printing system according to claim 1 or 2,
wherein the host device reduces the capacity of the intermediate code generated by receiving the notification to transmit the intermediate code to the printer.

4. The printing system according to claim 1,
wherein when the printer receives the intermediate code generated and transmitted from the host device and memory shortage occurs to disenable the storage of the intermediate code, the printer notifies the host device of the memory shortage, and
wherein the host device receiving the notification generates the intermediate code after simplification of an image to be printed for the predetermined range in which the memory shortage occurs, and transmits the generated intermediate code as the print data to the printer.

5. The printing system according to claim 4,
wherein the simplification is performed in different manners in accordance with the kind of image objects of the image to be printed.

6. A printer which generates bitmap data from print data received from a host device to perform printing for each predetermined range, generates an intermediate code from the print data to generate the bitmap data from the intermediate code when the print data is expressed by a printer control language, and generates the bitmap data from the intermediate code when the print data is expressed by the intermediate code,
wherein when the printer receives the print data expressed by the printer control language and memory shortage occurs during the generation of the intermediate code, the printer notifies the host device of the memory shortage, and
wherein the printer receives the intermediate code, which is generated by the host device, of the predetermined range in which the memory shortage occurs, and performs printing based on the received intermediate code.

7. A record medium recorded a driver program which causes a host device to generate and transmit print data, the host device issuing a print request to a printer which generates bitmap data from the received print data to perform printing for each predetermined range, generates an intermediate code from the print data to generate the bitmap data from the intermediate code when the print data is expressed by a printer control language, and generates the bitmap data from the intermediate code when the print data is expressed by the intermediate code,
wherein when the printer receives the print data expressed by the printer control language and memory shortage occurs during the generation of the intermediate code by the printer, the driver program causes the host device to receive a notification of the memory shortage from the printer, generate the intermediate code of the predetermined range in which the memory shortage occurs, and transmit the generated intermediate code as the print data to the printer.
